(19) United States
(12) Patent Application Publication
(10) Pub. No.: US 2013/0131855 A1
(43) Pub. Date: May 23, 2013

(54) CRIMPING PROCESS AND SYSTEM

(71) Applicant: CUSTOM MACHINING SERVICES, INC., Valparaiso, IN (US)

(72) Inventors: Joseph Vincent Intagliata, Hanna, IN (US); Micahel Lawrence Cincoski, Kouts, IN (US)

(73) Assignee: CUSTOM MACHINING SERVICES, INC., Valparaiso, IN (US)

(21) Appl. No.: 13/683,215

(22) Filed: Nov. 21, 2012

Related U.S. Application Data
(60) Provisional application No. 61/563,296, filed on Nov. 23, 2011.

(51) Int. Cl. G05B 15/02

(52) U.S. Cl. CPC G05B 15/02
USPC 700/117

(57) ABSTRACT

Processes and systems suitable for producing hose assemblies. The crimping processes and systems make use of a database that contains crimping settings for hose assemblies comprising combinations of hoses and fittings. The database further contains barcodes that are individually assigned to the hose assemblies and/or to the hoses and the fittings thereof. The barcodes are associated with the crimping settings within the database. In operation, a barcode is scanned into a controller of a crimping machine, the controller associates the barcode with a crimping setting for a hose assembly or for a combination of a hose and fitting, and then the crimping machine is operated to automatically use the crimp setting to produce the hose assembly by crimping the fitting to the hose.

### CROSS REFERENCE TO RELATED APPLICATIONS

This application claims the benefit of U.S. Provisional Application No. 61/563,296, filed Nov. 23, 2011, the contents of which are incorporated herein by reference.

### BACKGROUND OF THE INVENTION

The present invention generally relates to crimping equipment and crimping processes performed on hoses, which as used herein refers to any hose, tube or other type of conduit adapted to transport a fluid (liquid or gas) or protect electrical wiring or other hardware susceptible to damage.

Crimping processes often entail permanently attaching a fitting to at least one end of a hose to yield what is referred to herein as a hose assembly. Crimping processes are generally accomplished with a machine that performs a swaging or crimping operation that may involve forcing a die set around a fitting that has been loosely assembled onto the end of hose. The machine reduces the size of the fitting to what may be referred to as a crimp diameter, so that the fitting adequately squeezes the hose and provides a permanent connection. The desired crimp diameter for a fitting is often referred to as the “crimp specification” and is determined through appropriate design and testing. Once the proper crimp specification is determined for a particular type of hose and fitting combination, it is critical to control this size when assembling hoses and fittings of the same type. Consistently crimping to the same specification provides an accurate way to produce hose assemblies that will meet design and application requirements.

Through extensive testing, many hose and fitting manufacturers have determined the appropriate crimp specification for various hose and fitting combinations that they offer. This information is usually published and issued as crimp charts that are used by those that assemble the manufacturers' hoses and fittings. Crimp charts typically list combinations of specific hoses and specific fitting, and appropriate crimp settings, including crimp specification (diameter), for each particular combination of hose and fitting. As a nonlimiting example, manufacturers often provide customers with a table that identifies multiple different hose sizes (diameters), multiple different types of hoses for each hose size, one or more types of fittings for each hose type and size, and a crimp diameter for each combination of hose size, hose type, and fitting type. Manufacturers may also provide customers with a table containing information specific to a certain crimp machine. For example, for a hose size, hose type, and fitting type, a manufacture may identify a particular crimping machine, die set, and any unique crimp settings for the machine that may be recommended or required to obtain the desired crimp diameter.

Crimp charts must be maintained as changes occur or additions are made. New charts are typically published and made available to customers. Hose and fitting manufacturers routinely ensure that their customers have the latest charts so that hose assemblies having acceptable crimps can be consistently produced.

Published crimp charts are used by an operator to input the appropriate data into the machine to make a hose assembly. It is important for the operator to understand the crimp chart being used, since the information contained in these charts may be organized differently from one manufacturer's chart to the next. As evident from the previous discussion, at minimum an operator must use the appropriate crimp chart to find the correct crimp diameter (and possibly other crimp settings) for the specific hose and fitting combination to be assembled. The crimp settings must then be accurately transferred into the machine. Furthermore, the operator must select an appropriate die set. Though crimp settings are often specified in the crimp chart, certain settings may require a calculation. Some but not all machines are capable of automatically calculating such crimp settings. Once the above is accomplished, the machine can be operated to crimp the particular hose and fitting combination to the specified crimp diameter.

While the procedures outlined above are well known and widely followed in industries that utilize hose assemblies, it can be appreciated that there are various points within these procedures at which errors may occur that will result in a defective hose assembly. It can be further appreciated that there is an ongoing desire to reduce the likelihood of producing defective hose assemblies, including those that may result from operator error.

### BRIEF DESCRIPTION OF THE INVENTION

The present invention provides a process and system suitable for producing hose assemblies, including but not limited to hose assemblies intended for use in pneumatic or hydraulic systems.

According to a first aspect of the invention, a crimping process is provided that uses a database containing crimping settings for hose assemblies comprising combinations of hoses and fittings. The database further contains barcodes that are individually assigned to the hose assemblies and/or to the hoses and the fittings thereof. The barcodes are associated with the crimping settings within the database. The process further includes scanning at least a first of the barcodes into a controller of a crimping machine, operating the controller to associate at least the first barcode with a first of the crimping settings for a first of the hose assemblies or for a combination of a first of the hoses and a first of the fittings that when assembled form the first hose assembly, and then operating the crimping machine to automatically use the first crimp setting to produce the first hose assembly by crimping the first fitting to the first hose.

According to a second aspect of the invention, a crimping system is provided that includes the crimping machine, the controller, and the database described above, and further includes a scanner adapted to scan the barcodes into the controller.

A technical effect of the invention is the ability to more consistently produce hose assemblies that meet quality standards as a result of being produced in accordance with manufacturers' crimp charts whose specifications are stored in a database that is directly accessible by a crimping machine, such that the likelihood of defective hose assemblies resulting from operator error can be significantly reduce.

Other aspects and advantages of this invention will be better appreciated from the following detailed description.

### BRIEF DESCRIPTION OF THE DRAWINGS

FIG. 1 is a fragmentary cross-sectional view of a hose assembly of a type that can be crimped in accordance with this invention.

FIG. 2 is a perspective view of an example of a crimping machine that can be employed with embodiments of this invention.

### DETAILED DESCRIPTION OF THE INVENTION

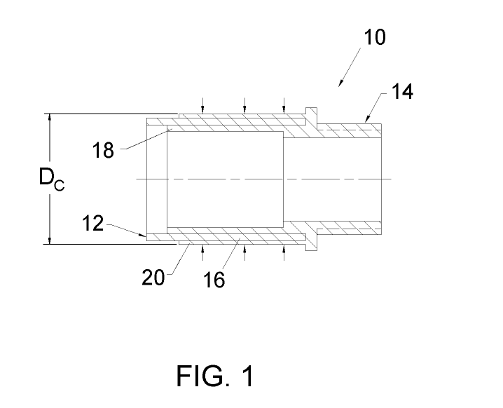

A preferred aspect of the present invention is to simplify procedures followed during the production of hose assemblies that entail crimping one or more fittings on a hose. FIG. 1 represents a nonlimiting example of a hose assembly 20 as including a hose 22 and fitting 24, with the end 26 of the hose 22 being received and trapped between an inner stem 28 and outer ferrule 30 of the fitting 24. The crimping action is the result of collapsing a die set (not shown), arranged around the circumference of the ferrule 30, in a controlled manner onto the ferrule 30 to apply a crimping force radially inwardly toward the centerline of the hose 22, as indicated by the arrows in FIG. 1. To meet reliability and manufacturing standards, the die set used to crimp the fitting 24 must sufficiently compress the fitting 24 to lock the fitting 24 onto the hose end 26. For this purpose, manufacturers typically designate a final crimp diameter “D_{C}” and an allowable tolerance for a given type and size of fitting 24 and hose 22. For purposes of discussing the invention, references will be made to the hose assembly 20 of FIG. 1, though it should be understood that the scope of the invention is not limited to any particular type or configuration of hose assembly, hose, or fitting.

While crimp charts provide crimp settings and other data that have been tested and approved by hose and fitting manufacturers to obtain desired crimp diameters for specific hose assemblies, these settings must be accurately transferred to the crimping machine that will be used to produce a hose assembly. This invention assigns a unique barcode to a particular hose assembly and/or to a particular hose and particular fitting(s) used to produce a particular hose assembly, which can be identified based on size, type, material, etc., of the hose and fittings. The barcode associates a particular hose assembly with crimp settings required to properly and consistently produce the hose assembly, including but not limited to crimp diameter “D_{C}” (crimp specification) and possibly other assembly information that may be associated with the particular crimping machine, die set, etc., and may influence the ability and likelihood of obtaining the desired crimp diameter. This barcode can then be scanned into a controller of a crimping machine to load the crimp settings into the machine.

Existing crimp tables can be modified to include unique barcodes for individual hose-fitting assemblies offered by manufacturers. As such, a crimp table employed by this invention would associate unique barcodes with unique combinations of hose (which may be identified by one or more of specification/part number, size (diameter), type, material, etc.), fittings (which may be identified by one or more of specification/part number, size, type, material, etc.), and crimp settings (including crimp diameter) for each unique combination of hose and fitting. A crimping machine operator simply scans the appropriate barcode from the crimp table to load the crimp settings. Each barcode automatically identifies the proper crimp settings for the particular hose-fitting combination being assembled.

As noted above, specific barcodes can be assigned to particular hose assemblies and/or to particular hoses and fittings that are assembled to produce particular hose assemblies. In embodiments in which the latter is provided, a barcode for a particular fitting can identify the fitting along with one or more types or sizes of hoses that can be assembled with that particular fitting. A barcode for a hose would similarly identify the particular hose along with possible choices of fittings. Scanning the barcodes for an individual fitting and hose would identify that hose-fitting combination, as well as the proper crimp diameter (specification) for the combination. This barcode information can be included in product catalogs along with details on the individual components. In addition to or as an alternative to the use of published crimp tables, hoses and fittings can be physically labeled with their corresponding barcodes.

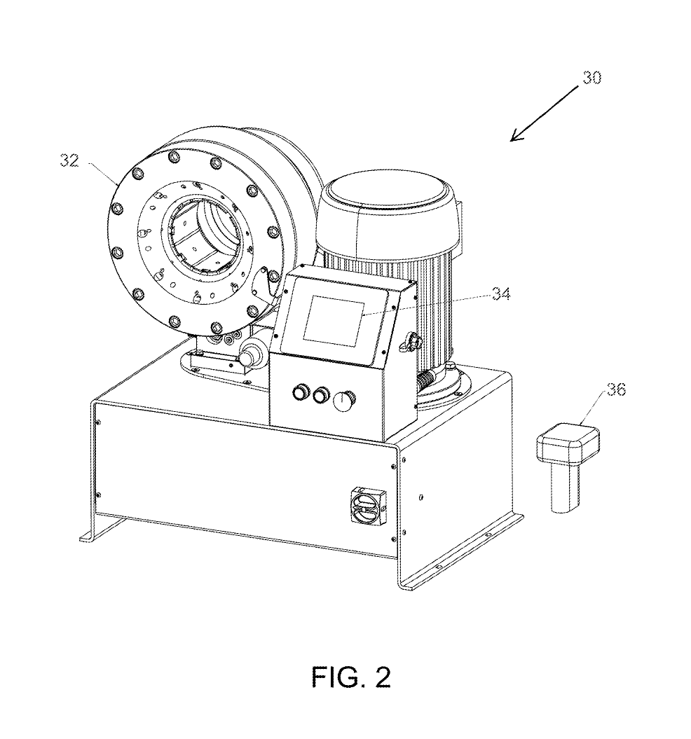

A barcode scanner can be fully integrated into the controls of a crimping machine. As represented in FIG. 2, a typical crimping machine 30 includes a crimping head 32 and an electronic controller 34. With a scanner 36 also shown in FIG. 2, a barcode (or barcodes) read from a crimp table or from labels on the particular hose and fittings to be assembled can be input into the controller 34, which then utilizes the barcodes to control the crimping head 32 in a manner that will crimp the fittings onto the hose and achieve the crimp specification (diameter) required by the manufacturer(s) of the hose and fittings. Instead of relying on an operator to input the crimp information for a particular hose and fitting, the crimp information is automatically identified by scanning the barcode associated with the particular hose and fitting combination or the barcodes individually associated with the hose and fittings. This procedure reduces potential operator errors from entering data incorrectly. Instead of looking through crimp tables and manually entering crimp settings into the controller 34, the barcode(s) can be quickly scanned to identify the crimping specification required by the particular combination of hose and fittings. The ability to identify assembly components through scanning simplifies the operator interface and accelerates the assembly procedure.

A database containing the barcodes and associated crimp settings can be stored in a mass storage memory device physically connected to or contained within the controller 34 of the crimping machine 30. In preferred embodiments of the invention, managing a system of barcodes that may be utilized by multiple machines makes use of a master database. The database can be stored as a “Crimp Bank” located on-site or remotely relative to one or more crimping machines. Integrating the Crimp Bank database with crimping machines through the Internet provides an opportunity to further enhance a hose assembly process. To ensure that the latest crimp settings are utilized by customers, updates to the Crimp Bank database can be posted on the Internet for download by customers into a mass storage memory device associated with the controller 34. Alternatively or in addition, the controller 34 can be manually or automatically connected to the Internet so that the controller 34 automatically accesses crimping settings from the Crimp Bank database in response to one or more barcodes read with the scanner 36. Manufacturers or a third party can maintain the Crimp Bank database to ensure that it contains the most current crimp settings for hoses and fittings in commercial use.

From the foregoing, it should be evident that the ability to identify particular hose assemblies and/or their individual components and the crimping settings associated therewith through unique barcodes enhances the operation of crimping machines and provides a means by which current product and crimping information can be accurately maintained. In addition, the use of the barcode scanner 36 at the machine 30 facilities the hose assembly process, simplifies the operator interface, and reduces if not eliminates problems caused by manually reading or entering the wrong crimp information from a crimp table. In cases where the individual parts are labeled with barcodes, a crimp chart may no longer be required. A Crimp Bank containing crimp settings that are maintained up to date and can accessed online to obtain available updates ensures that existing crimping machines are able to access and use the latest correct information supplied by manufacturers.

While the invention has been described in terms of specific embodiments, it is apparent that other forms could be adopted by one skilled in the art. For example, the physical configurations of the crimping machine 30 and scanner 36 could differ from that shown. Therefore, the scope of the invention is to be limited only by the following claims.

1. A crimping process comprising:
providing a database containing crimping settings for hose assemblies comprising combinations of hoses and fittings, the database further containing barcodes that are individually assigned to the hose assemblies and/or to the hoses and the fittings thereof, the barcodes being associated with the crimping settings within the database;
scanning at least a first of the barcodes into a controller of a crimping machine;
operating the controller to associate at least the first barcode with a first of the crimping settings for a first of the hose assemblies or for a combination of a first of the hoses and a first of the fittings that when assembled form the first hose assembly; and then
operating the crimping machine to automatically use the first crimp setting to produce the first hose assembly by crimping the first fitting to the first hose.

2. The crimping process of claim 1, wherein the database is stored in the controller of the crimping machine.

3. The crimping process of claim 1, wherein the database is stored remotely from the controller and is accessed by the controller via the Internet.

4. The crimping process of claim 1, wherein the controller accesses the crimp settings from the database via the Internet and stores the crimp settings for subsequent use by the controller.

5. The crimping process of claim 1, wherein the crimping settings of the database are for multiple different combinations of the hoses and the fittings.

6. The crimping process of claim 1, wherein the barcodes are individually assigned to the hose assemblies within the database.

7. The crimping process of claim 6, wherein the controller is operated to associate the first barcode with the first crimp setting for the first hose assembly.

8. The crimping process of claim 1, wherein the barcodes are individually assigned to the hoses and the fittings within the database.

9. The crimping process of claim 8, wherein the controller is operated to associate the first barcode with the first crimp setting for the combination of the first hose and the first fitting.

10. A crimping system comprising the crimping machine, the controller, and the database of claim 1 and further comprising a scanner adapted to scan the barcodes into the controller.

11. A crimping system comprising:
a crimping machine;
a controller associated with the crimping machine;
a database containing crimping settings for hose assemblies comprising combinations of hoses and fittings, the database further containing barcodes that are individually assigned to the hose assemblies and/or to the hoses and the fittings thereof, the barcodes being associated with the crimping settings within the database; and
a scanner adapted to scan at least a first of the barcodes into the controller;
wherein the controller is adapted to associate at least the first barcode with a first of the crimping settings for a first of the hose assemblies or for a combination of a first of the hoses and a first of the fittings that when assembled form the first hose assembly, and the controller is further adapted to operate the crimping machine to automatically use the first crimp setting to produce the first hose assembly by crimping the first fitting to the first hose.

12. The crimping system of claim 11, wherein the database is stored in the controller of the crimping machine.

13. The crimping system of claim 11, wherein the database is stored remotely from the controller and is accessible by the controller via the Internet.

14. The crimping system of claim 11, wherein the controller accesses the crimping settings from the database via the Internet and stores the crimping settings for subsequent use by the controller.

15. The crimping system of claim 11, wherein the crimping settings of the database are for multiple different combinations of the hoses and the fittings.

16. The crimping system of claim 11, wherein the barcodes are individually assigned to the hose assemblies within the database.

17. The crimping process of claim 16, wherein the controller associates the first barcode with the first crimping setting for the first hose assembly.

18. The crimping system of claim 11, wherein the barcodes are individually assigned to the hoses and the fittings within the database.

19. The crimping process of claim 18, wherein the controller associates the first barcode with the first crimping setting for the combination of the first hose and the first fitting.

20. A crimping system comprising:
a crimping machine;
a controller associated with the crimping machine;
a database containing crimping settings for hose assemblies comprising combinations of hoses and fittings, the database further containing barcodes that are individually assigned to the hose assemblies and/or to the hoses and the fittings thereof, the barcodes being associated with the crimping settings within the database, the database being stored remotely from the controller and being accessed by the controller via the Internet; and
a scanner adapted to scan at least a first of the barcodes into the controller;
wherein the controller is adapted to associate at least the first barcode with a first of the crimping settings for a first of the hose assemblies or for a combination of a first of the hoses and a first of the fittings that when assembled form the first hose assembly, and the controller is further adapted to operate the crimping machine to automatically use the first crimp setting to produce the first hose assembly by crimping the first fitting to the first hose.
